(19) United States
(12) Patent Application Publication
(10) Pub. No.: US 2005/0071207 A1
(43) Pub. Date: Mar. 31, 2005

(54) Visibility and synchronization in a multi tier supply chain model

(75) Inventors: Gregory Scott Clark, Hillsborough, CA (US); Mark Schenecker, Colorado Springs, CO (US); Steve Forman, Redwood City, CA (US); Rob Barrett, San Francisco, CA (US); Mark Young, Belmont, CA (US)

Correspondence Address: SWERNOFSKY LAW GROUP PC, P.O. BOX 390013, MOUNTAIN VIEW, CA, 94039-0013, US

(73) Assignee: E2open LLC, Redwood City, CA (US)

(21) Appl. No.: 10/672,081

(22) Filed: Sep. 26, 2003

(51) Int. Cl. G06F 17/60

(52) U.S. Cl. 705/7

(57) ABSTRACT

Methods and systems with which manufacturers can review reliable information about supply conditions including multiple supplier tiers, and maintain order collaboration for an extended supply chain. The manufacturer can: view updates to supply chain conditions; aggregate information from multiple products; collect and analyze information regarding supply chain performance of multiple supplier tiers; obtain feedback information for its design process in response to supply chain performance; review and enforce compliance with contract terms between the manufacturer and its suppliers; direct first tier and later tier suppliers to allocate parts in relatively short supply to particular projects within an enterprise in which the manufacturer is included; can define dictionaries of data shared among tiers, such as part numbers; and determine for which parts there is no strong preference in design or manufacture, allowing its first tier and later tier parts suppliers to use any design that meets design specifications.

### BACKGROUND OF THE INVENTION

1. Field of the Invention

This invention relates to a synchronized supply chain management network.

2. Related Art

OEM's (original equipment manufacturers) typically outsource production of their products, or components thereof. OEM's often rely on multiple such suppliers when sourcing components for their products. Known techniques for sourcing of parts include making arrangements with a first tier of suppliers. This first tier suppliers, and later tier suppliers (as described below), procure parts and materials to support the OEM's requirements. For example, the first tier suppliers might engage a second tier of suppliers to produce the design to the OEM's specification. The OEM would obtain its parts supply from first tier suppliers, who have agreed to price and other supply contract terms with the OEM. The first tier suppliers obtain their own parts for manufacture from a second set of second tier suppliers, whom in turn obtain their own parts for manufacture from third tier suppliers, and the like.

A first problem of these known techniques is that OEM's must rely on their first tier suppliers, and on their later tier suppliers, for the ability to timely purchase materials and manufacture components. If any supplier in the supply chain fails to timely purchase materials and manufacture components that form their part of the ultimate product, delivery of product to the OEM for the OEM to sell can be substantially adversely affected. Thus, the OEM does not have the ability to monitor demand and committed responses through the multiple tiers (that is, between first tier suppliers and later tier suppliers) of an extended supply chain.

A second problem of these known techniques is that OEM's are liable to their suppliers for components the OEM's request, even if demand or other market conditions change for the OEM. This has the effect that OEM's often must account (in their orders, and in their forecasts given to suppliers) for possible changes in demand or other market conditions, and often are unable to react sufficiently quickly to such changes to avoid adverse economic effect.

A third problem of these known techniques is that while OEM's have a contractual relationship with their first tier suppliers, and while that contractual relationship might specify constraints imposed on later tier suppliers, OEM's do not in general have a substantially reliable way to ensure that those constraints are in fact being followed. For example, OEM's do not in general have a substantially reliable way to ensure that prices reported to them by their first tier suppliers are accurate, or that discounts negotiated by the OEM's with later tier suppliers (such as for example if the OEM knows that its first tier suppliers buy in substantial bulk from a designated second tier supplier) are in fact applied, or that other terms or conditions the OEM desires to impose are in fact followed. Thus, the OEM does not have reliable information about pricing, source, or availability actually obtained by first tier or later tier suppliers. For just one example, the OEM does not know if its first tier suppliers accurately quote their own costs, with the effect that the OEM does not know if it can manufacture product at a lower cost.

One known method is to build a synchronized supply chain management network to manage communications between the OEM and its first tier suppliers. In systems using such methods, demand signals and supply signals are exchanged between automated systems at the OEM and at the first tier suppliers respectively, with the effect of providing greater automaton between the OEM and its first tier suppliers, and with the effect of providing the OEM with better data regarding its first tier supplier's operations. However, while this known method generally allows the OEM to review and process data from its first tier suppliers, it substantially fails to achieve several goals that would be advantageous to the OEM. For a first example, not intended to be limiting in any way, the OEM is not able with known methods to obtain relevant information regarding about parts sourcing for parts in the OEM's product that are not directly available from its first tier suppliers. For a second example, not intended to be limiting in any way, the OEM is not able with known methods to obtain visibility of relevant information from second tier and later tier suppliers.

The OEM also does not have reliable information about parts sourcing conditions for its first tier suppliers (or for its second tier suppliers or later tier suppliers). If circumstances change at the OEM, the OEM does not have a substantially reliable method for making the change of circumstances timely known to parts suppliers further down the supply chain. For one example, not intended to be limiting in any way, if the OEM places an order with its first tier suppliers, it will be substantially committed to that order, even in the event that the OEM no longer needs those parts. If the OEM had substantially greater visibility into operations of its second tier suppliers and later tier suppliers, it might be able to send information with sufficient alacrity that those later tier suppliers would not deliver parts (or raw materials) unnecessarily, with the effect that the OEM would obtain substantially greater flexibility with regard to order commitment. Otherwise, the OEM has to account, when placing orders to its first tier suppliers, for the possibility that it is requesting more parts than it will end up actually needing.

The OEM also lacks information transparency in the supply chain. As communications, such as purchase orders and supply commitments, are transferred through the supply chain, there is no substantially convenient repository for translation among these communications. In addition, there is no substantially convenient way of cross-referencing communications as they traverse the supply chain. The information flow for these purchase orders and supply commitments, and any cross-referencing communications, can often be quite complicated. For example, not intended to be limiting in any way, if a first tier supplier receives an order for part P from an OEM, that first tier supplier might need to order that part from a second tier supplier. The first tier supplier might aggregate that order with other orders received for the same part and/or from other OEMs. The first tier supplier might alternatively break that order up into multiple orders to the same or different second tier suppliers. In turn each second tier supplier might perform the same techniques, and the like, where each supplier in the supply chain is motivated to maximize its own profitability, possibly at the OEM's expense. This has the effect of making data collection difficult, and the effect that constructing an aggregated view of the supply chain can be difficult.

### SUMMARY OF THE INVENTION

The invention includes a method and system that a business entity (such as for example an OEM or a manufacturer, or a similar entity), at the head of a supply chain, can use to review aggregate information about supply conditions for parts procured by multiple tiers of suppliers, on behalf of the head of the supply chain. This method and system are capable of maintaining, on behalf of the head of the supply chain, an order collaboration system for an extended supply chain that incorporates data for multiple tiers of suppliers. In the order collaboration system, the head of the supply chain can view and analyze up-to-date supply chain conditions. Supported supply chain conditions can include, but are not limited to, price, source, availability, delivery schedules, backorders, supply interruptions, and possible exceptional events in the supply chain.

This has the effect that problems arising out of lack of visibility by the head of the supply chain for its suppliers “downstream” (as defined below) in the supply chain (that is, ultimately sources to the business entity collecting and analyzing the information) can be recognized and ameliorated by the head of the supply chain, either by the head of the supply chain taking direct action or by the head of the supply chain instructing its suppliers downstream in the supply chain to take certain actions. These problems, as described above, include (1) mismatches between supply and demand such as inadequate supply, which can have a substantial effect on revenue, (2) excess supply, sometimes caused by order changes, and which can have a substantial liability impact on the head of the supply chain, and (3) compliance by suppliers with contractual obligations, such as for example, where suppliers themselves source their parts from and whether they are truthful about the margins they report to the head of the supply chain.

In an aspect of the invention, a head of the supply chain or an n^{th} tier supplier in the supply chain can (for suppliers downstream in the supply chain) collect and analyze information regarding supply chain performance of multiple tiers of suppliers, including costs, ship dates, and the like. Performance analysis can include an evaluation of how a selected supplier performed with regard to price adjustments, a performance assessment of a selected supplier with regard to promised supply amounts or delivery schedules, whether the selected supplier has had an unusual number of quality defects, or whether there have been an unusual number of supply chain exceptions for that supplier. Supply chain exceptions can include, but are not limited to, approval of price variances and the like and revoking or changing manufacturing forecasts.

In an aspect of the invention, a head of the supply chain or an n^{th} tier supplier in the supply chain can obtain from the system a dictionary of translations of transitive information in the supply chain. For example, this aspect of the invention can produce a translation among part numbers used in each tier of the supply chain per order or per part. These dictionaries are useful for cross-tier communication, exception handling, discussion of adherence to contract terms, as well as other aspects of supply-chain operation.

In an aspect of the invention, the head of the supply chain or an n^{th} tier supplier in the supply chain can (for suppliers downstream in the supply chain) aggregate information concerning multiple products, thus providing the ability to review aggregated supply chain conditions for the extended supply chain for an enterprise. The head of the supply chain is included in or integrated with, for all suppliers downstream in the supply chain. The head of the supply chain can obtain supply chain information from which it can determine, for each part used in any one of a set of multiple products, a set of supply chain information aggregated over the entire enterprise.

In an aspect of the invention, a design engineer (working at or with the head of the supply chain) can obtain feedback information for its design process in response to supply chain performance. Design process feedback information can pertain to selected preferred parts, selected preferred suppliers (at one or more of the multiple tiers), and the like. The design process feedback info can include, but is not limited to, price for potentially used or planned parts and part availability. For example, the head of the supply chain, in response to aggregated information, can determine those parts with the best price, have a high assurance of availability, or those that do not require new approval for use, (and not just a technical fit), thus eliminating a source of otherwise additional cost and delay.

In an aspect of the invention, the head of the supply chain can review and ensure compliance with contract terms between the head of the supply chain and its suppliers. For example, where the head of the supply chain has required its first tier suppliers to obtain parts under selected contract conditions the head of the supply chain can determine from examination of information maintained by the order collaboration system whether second tier (or later tier) suppliers are complying with those conditions, or whether those conditions are in fact being observed. Supported contract term compliance can include delivery price, delivery quantity (and price-quantity breakpoints), terms for parts returns, delivery methods, and the like.

In an aspect of the invention, a head of the supply chain can direct its first tier and later tier suppliers in the supply chain to allocate parts that are in relatively short supply, or otherwise resource-limited, to particular projects among all of the projects in which the head of the supply chain is engaged with the suppliers. For example, the head of the supply chain can direct downstream parts suppliers (as defined below) to allocate scarce or expensive parts for those elements (such as for example, a particular component) that the head of the supply chain deems to be relatively high priority, rather than those elements the head of the supply chain deems to be relatively low priority.

### BRIEF DESCRIPTION OF THE DRAWINGS

FIG. 1 shows a high-level view block diagram of a system for extended supply chain visibility in an outsourced manufacturing model.

FIG. 2 shows a block diagram showing the architecture of a hub that is used in a system for extended supply chain visibility in an outsourced manufacturing model.

FIG. 3 shows a process flow diagram of a method of operating an order collaboration system for an extended supply chain.

### INCORPORATED DISCLOSURES

Inventions described herein can be used in conjunction with technology described in the following documents:
application Ser. No. 09/823,888, filed Mar. 30, 2001, in the name of inventor Gregory Scott Clark, titled “Private Collaborative Planning in a Many-to-Many Hub”, attorney docket number 215.1001.01, and applications claiming priority therefrom.
application Ser. No. 10/132,072, filed Apr. 24, 2002, in the name of inventor Gregory Scott Clark, titled “Multi-Hub connectivity in a System for Collaborative Planning”, attorney docket number 215.1004.02, and applications claiming priority therefrom.
application Ser. No. 09/967,905, filed on Sep. 28, 2001, in the name of inventors Gregory Scott Clark, Chris Haag, and Christian Buckley, titled “Method for Business-to-Business Collaborative Viral Adoption”, attorney docket number 215.1010.01, and applications claiming priority therefrom.
application Ser. No. 09/967,907, filed on Sep. 28, 2001, in the name of inventor Gregory Scott Clark, Titled “Securing Information in a Design Collaboration and Trading Partner Environment”, attorney docket number 215.1008.01, and applications claiming priority therefrom.

These documents are hereby incorporated by reference as if fully set forth herein, and are sometimes referred to herein as the “Incorporated Disclosures”.

### DETAILED DESCRIPTION OF THE INVENTION

The description herein includes a preferred embodiment of the invention, including preferred data structures and process steps. Those skilled in the art would realize after perusal of this application, that embodiments of the invention might be implemented using a variety of other techniques not necessarily specifically described herein, without undue experimentation or further invention, and that such other techniques would be within the concept, scope, and spirit of the invention.

Lexicography

The following terms relate or refer to aspects of the invention or its embodiments. The general meaning of each of these terms is intended to be illustrative and in no way limiting.
first tier, second tier, later tier—In general, these terms refer to any business entity in the extended supply chain, with the tier number representing the distance in purchaser-supplier relationships from the manufacturer at the head end of the extended supply chain. Thus, first tier parts suppliers are those who interact directly with the manufacturer, second tier parts suppliers are those who interact directly with the first tier, and later tier parts suppliers are those who interact directly with the second tier or other later tier parts suppliers. Although a preferred embodiment is described with the assumption that each tier of parts suppliers includes entities separate from all other tiers, this is not a particular requirement of the invention; for example, the manufacturer can in fact be a parts supplier in its own extended supply chain, and thus be a second tier or later tier parts supplier to itself.
downstream—In general, this term refers to any business entity in the extended supply chain that is more remote from the head of the supply chain. Thus, a 2^{nd} tier supplier is downstream from a 1^{st} tier supplier, and the like.
manufacturer—In general, this refers to a business entity at the head end of the extended supply chain. Although an embodiment of the invention is described with the manufacturer represented as an OEM, there is no particular requirement that the manufacturer has this particular role. For example, an embodiment of the invention can be used by one or more of the parts suppliers represented herein, with that parts supplier being considered the “manufacturer” for all parts suppliers downstream from it in the extended supply chain.
parts supplier—In general, this refers to any business entity in any tier of the extended supply chain that supplies parts or components to another entity in the extended supply chain.
supply conditions, supply chain conditions—In general, this refers to any data or information about parts suppliers or their activities that might be of value to the manufacturer. In a preferred embodiment, these include selected business characteristics such as parts pricing, amounts of parts supplied, and the like. However, there is no particular requirement that the data or information is limited to these particular examples.
supply chain collaboration—In general, a process in which buyers and business partners interact with each other, as well as first, second and later tier suppliers at a hub with respect to sourcing, supply and demand planning, inventory management, and other aspects of transactions such as may relate to one or more projects or work flows.
order collaboration—In general, this refers to a technique in which buyers and trading partners use a hub interact to cooperatively on processes such as ordering goods (including discrete and blanket purchase orders), forecasts, advanced ship notices, invoicing, shipment receipt notifications, inventory status, and other aspects of planning and executing an order for parts or components.
exceptional events—In general, this refers to any event that is unexpected in the process of ordering, building, shipping and paying for goods. One example of an exception event is a mismatch between actual or forecasted need for a particular part, component or assembled product and the supplies required to manufacture or assemble such an item.
brokering groups—In general, this refers to a set of zero or more suppliers, other brokering groups, or other entities willing to speculate on trade within that group. Brokering groups will typically be opt-in. That is, entities will choose to participate in a brokering group. It is also possible that entities can be assigned to participate in a group. For example, all entities in a supply chain may be entered as a single group.
visibility—as used herein, “visibility” refers to the ability to determine the status of an order across multiple supply chains, within a tier of a single supply chain, or within different divisions of the same entity.

The scope and spirit of the invention is not limited by any of these definitions, or by any specific examples mentioned therein, but is intended to include the most general concepts embodied by these and other terms.

System Elements

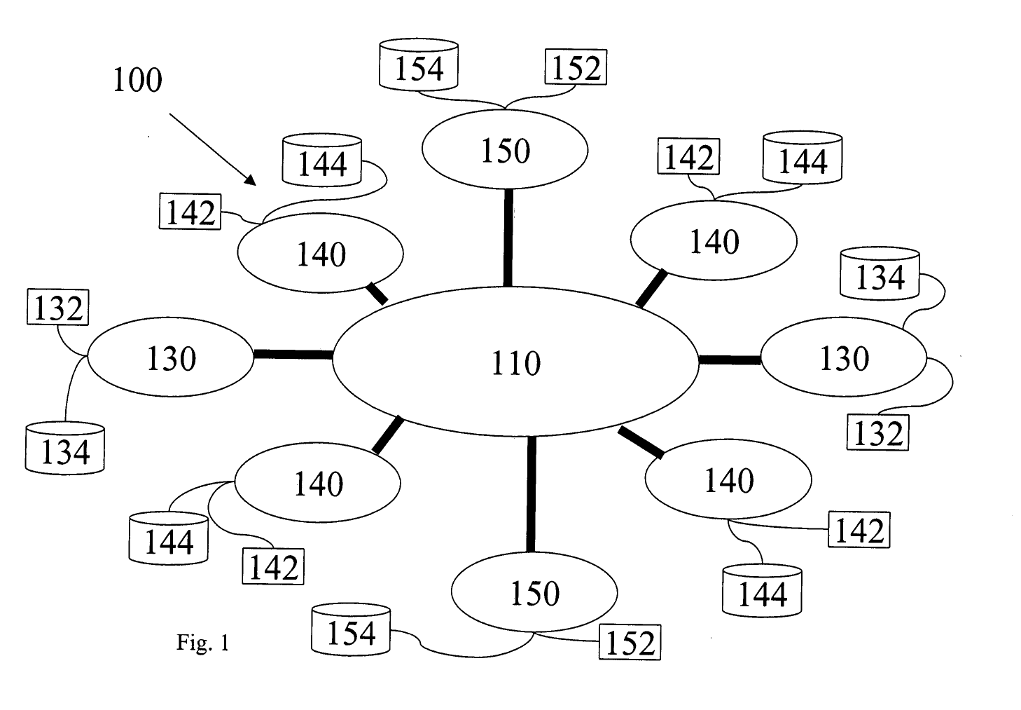

FIG. 1 shows a block diagram of high-level view of a system for extended supply chain visibility in an outsourced manufacturing model.

A system 100 includes a hub 110, a set of first tier supplier facilities 130.1, a set of second tier supplier facilities 130.2, a set of Nth tier supplier facilities 130.N, where N is an integer greater than zero and 130.N represents that Nth tier supplier, and at least one OEM or other manufacturing facility 150. Communication between the hub 110 and the set of first tier supplier facilities 130.1, later tier supplier facilities 130.N, and OEM or other manufacturing facility 150 is conducted by way of a communications network 160 (not shown).

Hub and Spoke Model

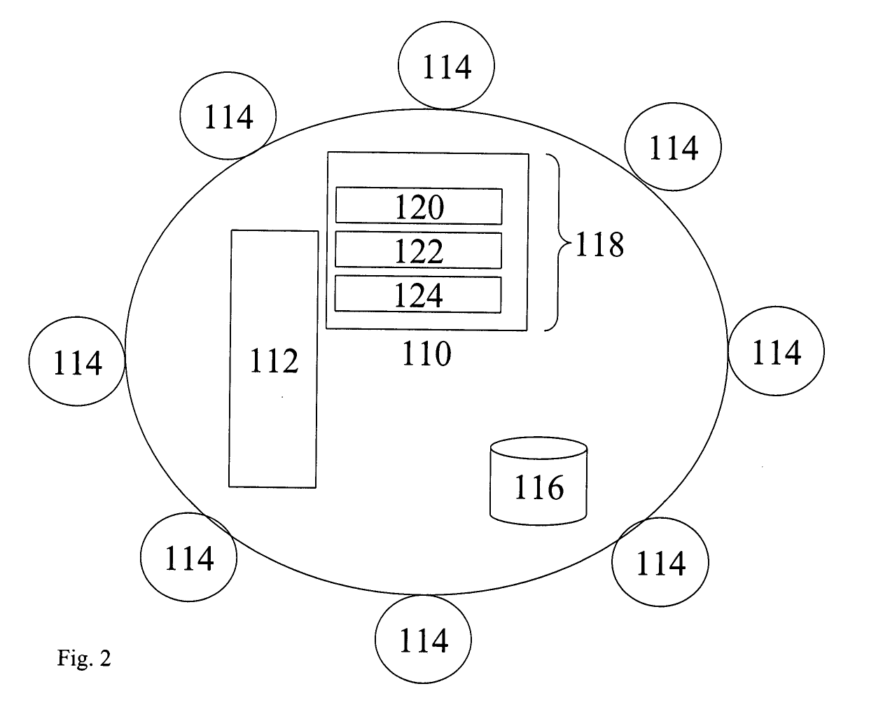

The hub can be either a single entity or a multi-hub system acting as a single hub as described in the Incorporated Disclosures. An aspect of the hub 110 is a web site dedicated to supply chain management, collaborative design and managing product lifecycle business processes. The hub 110 also includes a database 116 and an order collaboration system 118. These latter elements are further described in FIG. 2.

In one embodiment, the OEM 150 includes a computer or electronics manufacturer. The first tier suppliers 130.1 produce parts and components used by the OEM 150 and can include one or more contract manufacturers or EMS (external manufacturing service) that manufactures goods on behalf of the OEM 150. The later tier suppliers 130.N include suppliers of parts or components used by the first tier supplier 130.1 or by a later tier supplier 130.N that is closer in the supply chain to the OEM 150. In other embodiments, the OEM 150, first tier supplier 130.1 and later tier suppliers 130.N may represent a different manufacturing industry such as automobile or aircraft manufacturers.

Every tier of suppliers 130.N include at least one workstation 132 and a database 134. The workstation 132 is used to initiate and receive communications from the hub 110. These communications include messages to the hub 110 or messages to a later tier supplier 130.N, an earlier tier supplier 130.N, or to the OEM 150 that are directed to the intended recipient by way of the hub 110. The database 134 includes information that is used to update information in database 116. This information is described in detail below.

Each OEM 150 includes at least one workstation 152 and a database 154. The functionality of workstation 152 and database 154 is similar to the functionality of workstation 132 and database 134. However, communications from the workstation 152 include messages to the hub 110 or messages to a first tier supplier 130.1 or a later tier supplier 130.N that are directed to the intended recipient by way of the hub 110 or directly to the recipient with a copy sent to the hub. The database 154 includes information that is used to update information in the database 116.

The elements of a system 100 may be viewed as a hub and spoke model, in which the hub 110 is at the center of the model and the first tier supplier facilities (including the EMS facility) 130.1 and later tier supplier facilities 130.N and at least one OEM or other manufacturing facility 150 form the spokes of the model. Other spokes included in the hub and spoke model are distributors, fulfillment centers and other entities involved with servicing the supply chain. Other embodiments of the system 100 may be configured differently, however. For example, the services provided by the hub 110 may be implemented on the client side. In such embodiments, communication flows directly between from the OEM 150, first tier suppliers 130 and later tier suppliers 140 and is not mediated by the hub 110. In such an embodiment, in order to take advantage of the ability of the hub 110 to aggregate the shared state of the supply chain, a copy of the communication would be sent to the hub 110. Additionally, the hub may be implemented as a multi-hub system with the multiple hubs acting as a single hub. This is described in more detail in the Incorporated Disclosures.

The hub 110, the OEM(s) 150, the first tier supplier(s) 130.1 and later tier supplier(s) 130.N are coupled using a communication network 160. In a preferred embodiment, the communication network 160 includes a computer communication network, such as the Internet. However, in alternative embodiments, the communication network 160 might include an intranet, extranet, VPN (virtual private network), ATM system, a portion of a private or public PSTN (public switched telephone network), a frame relay system, or any other communication technique capable of performing the functions described herein.

Hub Architecture

FIG. 2 shows a block diagram showing the architecture of a hub that is used in a system for extended supply chain visibility in an outsourced manufacturing model.

The hub 110 includes one or more servers 112, a set of portals 114, a database 116 and an order collaboration system 118.

Each of the one or more servers 112 includes a processor, program and data memory, and operates under control of software to perform the tasks described herein. The server 112 is capable of using a message transfer protocol, such as HTTP, FTP, or a variant thereof, to send and receive information to and from the set of first tier supplier facilities (including the EMS facility) 130.1 and later tier supplier facilities 130.N and at least one OEM or other manufacturing facility 150 and transmit responses and various notifications thereto. In a preferred embodiment, the server 112 uses a version of HTTP, SHTTP or at least some features thereof.

The set of portals 114 include at least one portal 114 for each first tier supplier facility 130.1, later tier supplier facility 130.N, and OEM or other manufacturing facility 150. In some embodiments, each entity has a single portal 114. In other embodiments, different divisions of a single entity may each have their own associated portal 114. These portals 114 include a software element for receiving, parsing, translating, sending and generating information received by the entity associated with the portal 114 into a form such that the information can be aggregated or manipulated by the order collaboration system 118. The reverse process also occurs: the portals 114 can also convert information from a standardized format such as used by the order collaboration system 118 into a format that is easily apprehensible by the recipient of the information. While these portals are logically distinct, multiple or all of the portals could be the same portal. In such an embodiment, the portal would determine the identity of each sender. Therefore, a single portal could be used for multiple by one or more OEM(s) 150, first and later tier supplier(s) 130.N.

The database 116 is coupled to the server 112, either in the main memory of the server 112 or in a logically remote location. In one embodiment, the database 116 may be a relational or object oriented database. The database 116 includes data from the first tier supplier facilities (including the EMS facility) 130.1, later tier supplier facilities 130.N and at least one OEM or other manufacturing facility 150. This data includes at least some of the following:
Inventory information, including what types and quantifies of parts or components are available to a potential buyer.
Pricing schedules, including prices for different volumes of particular parts or components and such discounts as may be available.
Planning forecasts, including list of parts that an entity expects to have available in the future, the list of components that an entity expects to manufacture by a particular data and a list of dates in which alpha, beta and other product versions are scheduled to be marketed.
Design information relating to the design or manufacture of a particular part that it available or may become available for purchase or is desired by a particular entity.
Sourcing information, including list of suppliers from whom an entity has acquired a particular part in the past or from whom such a part may become available in the future.
Contract terms for contracts between the OEM and the EMS, the EMS and a first tier supplier, a first term supplier and a second tier supplier and between other parties.
Invoices for pending and fulfilled orders, so as to provide a record for what was ordered and what was shipped and what may be back ordered.
Purchase orders relating to pending or fulfilled orders.
Advance ship notices, so as to put an entity on notice that parts were shipped.
Shipment receipt notices, so as to put an entity on notice that parts have been received.
BOMS (Bills of Manufacture) for pending or fulfilled orders.
   and
Other information such as may be used in supply chain management, order collaboration and design collaboration.

Portions of this information may be private or public, depending upon preferences set by the party that “owns” the information. In many instances, the owner of the information is the party most closely linked to the OEM (or the OEM itself); however in other instances, the owner of the information is the party to whom the information pertains (for example, credit information). Furthermore, some of the information owned by a particular entity may be public to certain defined parties, whereas the balance of the information may be public to everyone or completely private (for example, information is public to an OEM is not necessarily public to other entities in the supply chain). Regardless whether particular information in the database 116 is designated public or private, the information is visible to the order collaboration system 118.

The order collaboration system 118 includes software modules that manipulate information stored in the database 116 to perform various functions involving determination of costs, allocation of parts, evaluations of entities in a supply chain and similar tasks on behalf of an OEM or other manufacturing entity 150. These software modules include elements for generating and receiving messages 120, (including demand messages and supply signal messages), an aggregating module 122, and a reporting module 124 for generating reports.

The elements for generating and receiving messages 120 include at least one software element for processing demand messages (such as demands for a particular product or requests for information), supply messages (such as an indication that a product is available) and special messages requesting that data be aggregated or summarized.

The aggregating module 122 compares and aggregates different types of information relating to at least some of the following:
The price of an electronic or computer product, part or component from various different first tier suppliers 130.1 and later tier suppliers 130.N;
The quantity of a particular part from one or more first tier suppliers 130.1 and later tier suppliers 130.N;
A list of different electronic or computer parts that may be used in a similar manner or for a similar purpose;
A dictionary for cross-tier translation of part numbers and other information that is shared among tiers;
The costs that a supplier at any tier 130.N has incurred for parts used in the manufacture of a particular product or component;
The projected costs of a quantity of components based upon the cost of parts from multiple first tier suppliers 130.1 and second tier 130.N suppliers;
The availability of a particular part or parts provided by a first tier supplier 130.1 or a later tier supplier 130.N;
   and
The allotment of parts that a first tier supplier 130.1 or later tier supplier 130.N has dedicated to a particular design.

In a preferred embodiment, the aggregating module 122 aggregates and manipulates information based upon different preferences set by the OEM or other manufacturing facility 150, by first tier suppliers 130.1, or later tier suppliers 130.N.

In a preferred embodiment, the brokering module 126 determines from the aggregating module 122 where there is a dearth or a surplus of a certain part or product. The brokering module 126 then looks for matching pairs of death and surplus within brokering groups and attempts to broker a deal. Entities can choose whether to participate in the brokered deal. A fee may be charged for brokering the deal. If the brokered deal is not accepted by the entities, the brokering module will look for other deals to broker on that part and other parts.

In a preferred embodiment, the brokering module 126 can adopt any strategy to match dearth and surplus. These strategies can include, but are not limited to:
Match a single dearth, surplus pair for each part or product at a time and wait for a response before attempting another match on that part or product, whereby a preferred order of matching pairs can be maintained.
Match multiple dearth, surplus pairs and wait for the first to respond, whereby the fastest responses makes the transaction.
Match multiple dearth, surplus pairs and collect all responses and decide, based on criteria such as profit for the hub, preferred vendor lists, or other criteria to match a single or multiple of the pairs for a single part or product.
Allow partial matches of the dearth, surplus, whereby, even if no pair can completely resolve the dearth, the dearth is mitigated.
   and
Allow multiple partial matches of the dearth, surplus, whereby even if no pair can completely resolve the dearth, the dearth can be better mitigated or resolved by allowing multiple partial matches.

In a preferred embodiment, brokering groups are lists of suppliers, manufacturers, other brokering groups, and other entities that wish to speculate on trade within that group. They are stored within the memory of the brokering module 126 or in the memory of any entity or module within the hub 110 or outside the hub 110 to which the brokering module 126 has access. Brokering groups contain zero or more entities. A single entity can participate in zero or more brokering groups. A brokering group will typically be opt-in. That is, entities will choose to participate in the brokering group. It is also possible that entities will be assigned to brokering groups. For example, all entities in an extended supply-chain may be assigned to a single brokering group if legal and appropriate. In any case, an entity can always choose to opt-out of a brokering group in which it is participating. The members of a brokering group can be within a single extended supply chain or can be between extended supply chains.

The aggregating module 122 generates statistical values corresponding to aggregates such as price, volume and other aspects of the information so as to comply with a particular request from an OEM 150 for a particular report. The reporting module 124 receives data from the aggregating module and uses this data to generate reports for an OEM 150. The aggregated information is submitted to a reporting module 124 that generates a report on behalf of the OEM 150 or Nth tier supplier 130.N. These reports involve at least some of the following:
A review of aggregated supply chain conditions with respect to an enterprise in which the manufacturer is involved or plans to become involved;
A summary of feedback for a design process with respect to aspects of the design, parts that can be used in the design, or sourcing issues;
A compliance determination with regard to contract terms involving the price, quantity, or delivery date of a particular part based upon contracts between the OEM 150 and an Nth tier supplier 130.N or between two Nth tier suppliers 130.N;
An analytic summary of data with respect to supply chain performance;
A suggestion to direct a first tier supplier 130.1 or later tier supplier 130.N to allocate parts for a particular project;
A suggestion to direct a first tier or later tier suppler 130.N to use a part that meets a particular design and/or pricing specification rather than to use a part from a particular vendor;
   and
Other sourcing and design issues.

These reports provide the OEM or other manufacturing facility 150 with reliable information about pricing and profits margins actually obtained by the EMS. This information can be used assist the OEM in better evaluating the feasibility of manufacturing the product at a lower cost, a different volume or for a different shipping time.

In other embodiments, reports can be provided to a first tier supplier 130.1 or a later tier supplier 130.N. In such embodiments, data from multiple first tier suppliers 130.1, later tier suppliers 130.N and an OEM 150 is aggregated and summarized. However, the reports generated on behalf of a first tier supplier 130.1 or later tier supplier 130.N are different in substance from the ones generated on behalf of an OEM 150. For example, reports generated on behalf of a first tier supplier 130.1 or a later tier supplier 130.N involve any of the following:
A review of aggregated supply chain conditions with respect to an enterprise in which the first tier supplier 130.1 or later tier supplier 130.N is involved or plans to become involved. Such reviews may be particular useful when creating bids to be presented to OEMs or other entities closer to the head of the supply chain;
A compliance determination with regard to contract terms involving the price, quantity or delivery date of a particular part based upon contracts between first tier suppliers 130.1 and later tier suppliers 130.N. Such reports are particular useful when determining whether a later tier entity is complying with the terms of a contact;
An analytic summary of data with respect to supply chain performance. An evaluation of different parts with respect to determining which parts to use in manufacturing a particular component;
   and
Other sourcing and design issues.

The reports described above can be used by first tier suppliers 130.1 and later tier suppliers 130.N to aid in dealing with sourcing issues related design collaboration.

Hub Communication

A hub 110 is used to process communication between an OEM or other manufacturer 150 to multiple first tier suppliers 130.1, between the first tier suppliers 130.1 and second tier suppliers 130.2, and between second tier suppliers 130.2 and third tier suppliers 130.3. The diagram and system described are intended to be in no way limiting, but instead represent an uncomplicated system with enough detail to describe the communication and data collection process. Alternative embodiments could include more or fewer tiers of suppliers, more or fewer suppliers per tier, more manufacturers 150.

All communications among the OEM 150 and suppliers 130.N are routed through the hub 110. The hub maintains a copy of all communication among entities in its database 116. The copy of the communication can be of the full message sent or can be a subset of the information based on the legal arrangement among the OEM 150 and the suppliers 130.N. At minimum, the copy of the communication must maintain data related to the fields for which people will build or will want to build dictionaries of cross-tier translation. Some common examples of information for which it will be useful to build such dictionaries are: part number mapping, purchase order number mapping, advanced ship notice number mapping, and invoice number mapping.

The dictionary of cross tier translation is created by building tables of cross-referenced data from corresponding messages between the OEM 150 and a first tier supplier 130.1 or between and two Nth tier suppliers 130.N. The cross-reference is identified in the hub 110 by identifying a token placed in each message so that the hub can identify which previous message is the causal antecedent of a given one. This token can be, but is not limited to, a number generated by the hub 110 and then included by the OEM 150 or Nth tier supplier 130.N, the incoming purchase order number, part number, invoice number, advanced ship notice number, or any other number that can uniquely identify the causal antecedent of the message.

Once the causal antecedent for the message is identified, the hub 110 can determine the cross-tier information from the two messages. From multiple of these relationships, the aggregating module 122 can determine the transitive relationship, across the supply chain, of any information passed and translated among the entities in the supply chain.

The reporting module 124 can report these dictionaries when interested entities access the order collaboration system 118.

Method of Operation

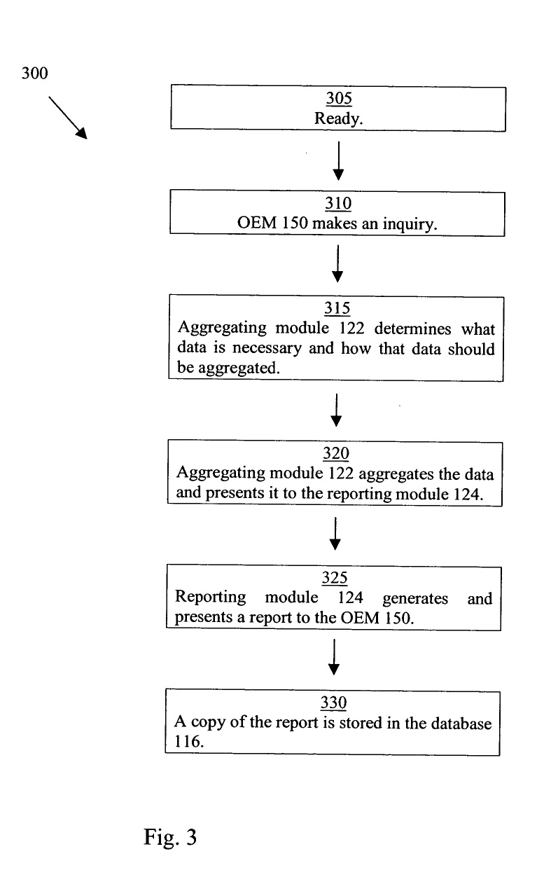

FIG. 3 shows a process flow diagram of a method of operating an order collaboration system for an extended supply chain.

A method 300 includes a set of flow points and process steps as described herein using a system 100, including the hub 110, the first tier suppliers 130.1, the later tier suppliers 130.N, the OEM 150 and the communications network 160.

Although by the nature of textual description, the flow points and process steps are described sequentially, there is no particular requirement that the flow points or process steps must be sequential. Rather, in various embodiments of the invention, the described flow points and process steps can be performed in a parallel or pipelined manner, either by one device performing multitasking or multithreading, or by a plurality of devices operating in a cooperative manner. Parallel and pipelined operations are known in the art of computer science.

In a flow point 305, the system 100 is ready to begin. The first tier suppliers 130.1 and later tier suppliers 130.N have stored inventory and pricing information in the database 116.

In a step 310, an OEM 150 makes an inquiry. The inquiry may involve any of the following:
Determining whether a contract manufacturer is complying with the terms of a contract.
Determining the overall projected cost of a particular design based upon prices from multiple first tier suppliers 130.1 and multiple later tier suppliers 130.N.
Determining the overall projected cost of a particular design using different parts.
Determining if there is a more cost efficient way to manufacture a particular design.
Determining the relative costs associated with different aspects of manufacturing a particular design (for example determining the manufacturing costs of different components used in the final product).
   and
Making any other design or manufacturing determination involving price and quantity of parts or components.

The inquiry is made by contacting the hub 110 using the communications network 160. The OEM 150 interacts with the element for generating and receiving messages 120. The inquiry is parsed and passed on to the aggregating module 122.

In a step 315, the aggregating module 122 determines what data is necessary to answer the inquiry and how that data should be aggregated to provide an answer. The data in question involves price, inventory, and shipping information pertaining to one or more past designs or one or more prospective designs or some combination of past and prospective designs. This data may include (1) current data from multiple suppliers across multiple supply chains and (2) data from past or ongoing transactions.

In a step 320, the aggregating module 122 aggregates the data and presents it to the reporting module 124.

In a step 325, the reporting module 124 generates a report that is responsive to the original inquiry and presents the report to the OEM 150 by way of the portals 114. As noted earlier, these reports concern at least some of the following:
A review of an aggregated supply chain conditions with respect to an enterprise that the manufacturer is involved in or plans to become involved in.
A summary of feedback for a design process with respect to aspects of the design, parts that can be used in the design or sourcing issues.
A compliance determination with regard to contract terms involving the price, quantity or delivery date of a particular part.
An analytic summary of data with respect to supply chain performance.
A suggestion to direct a first tier supplier or later tier supplier to allocate parts for a particular project.
A suggestion to direct a first tier or later tier suppler to use a part that meets a particular design specification rather than to use a part from a particular vendor.
   and
Other aspects of sourcing, design, and compliance such as may be of interest to an OEM.

These reports provides the OEM or other manufacturing facility 150 with reliable information about pricing and profits margins actually obtained by Nth tier suppliers 130.N such as an EMS. The OEM 150 can better evaluate the feasibility of manufacturing the product at a lower cost, a different volume or for different shipping times.

In a step 330, a copy of the report is stored in the database 116 where the OEM 150 can access it. If necessary inventory levels in the database 116 are adjusted at this time to reflect changing conditions.

In other embodiments, a variant of the method 300 can also be performed on behalf of a first tier supplier 130.1 or a later tier supplier 130.N. In such embodiments, the first tier supplier 130.1 or the later tier supplier 130.N makes the original inquiry. Reports are generated and transmitted to the first tier supplier 130.1 or later tier supplier 130.N. Such reports can be particular useful when preparing bids, determining the most economically feasible way to manufacture a particular component and other comparable activities.

### ALTERNATIVE EMBODIMENTS

Although preferred embodiments are disclosed herein, many variations are possible which remain within the concept, scope, and spirit of the invention. These variations would become clear to those skilled in the art after perusal of this application.
For just one example, those of ordinary skill would understand, after reading this application, that many possible variations of the invention or its use could include use of this invention outside of manufacturing. The invention could be used with regard to extracting or producing natural materials or raw materials (such as for example: agriculture, building or construction, hydroponics, mining, oil drilling, power production and transmission, and the like) for which extracting or producing involves a chain of entities, with regard to services (such as for example: architecture, engineering design, information searches, professional services, and the like) for which the provision of services involves a chain of entities, such as for example when some of the services are subcontracted, and with regard to trading of commodities or products (such as for example: factoring, futures trading, wholesaling, and the like) for which the trading itself involves a chain of entities.

Those skilled in the art will recognize, after perusal of this application, that these alternative embodiments are illustrative and in no way limiting.

1. A system including
one or more business entities defining a head of a supply chain;
one or more sets of tiers of suppliers, wherein each said set of tiers is disposed in an extended supply chain;
an electronic commerce facilitator coupled to said one or more business entities and said one or more sets of tiers of suppliers;
a database including information from said one or more sets of tiers of suppliers relating to two or more of the following: price, inventory, delivery schedules, backorders and supply interruptions, exceptional events, contracts, and past transactions; and
an order collaboration system coupled to said electronic commerce facilitator, whereby said one or more business entities can view updates to supply chain conditions for said plurality of said tiers.

2. A system as in claim 1, including an aggregation element for aggregation of information relating to one or more products associated with said one or more business entities, wherein said information is stored in said database.

3. A system as in claim 2, including a presentation element, wherein said presentation element presents aggregated information to said one or more business entities, wherein said one or more business entities can review aggregated supply chain conditions for the extended supply chain for an enterprise in which the one or more business entities is included; and wherein said one or more business entities can obtain supply chain information from which it can determine, for each part used in any one of a set of multiple products, set of supply chain information aggregated over said one or more business entities individual enterprise.

4. A system as in claim 2, wherein said aggregation element includes a performance evaluation element capable of collecting and analyzing information regarding supply chain performance of multiple tiers of suppliers.

5. A system as in claim 2, wherein said information regarding supply chain performance includes at least one of: costs, ship dates, evaluation regarding whether a selected supplier performed well with regard to price adjustments, with regard to promised supply amounts or deliver schedules, whether the selected supplier has had an unusual number of quality defects, or whether there have been an unusual number of supply chain exceptions for that supplier.

6. A system as in claim 2, including a brokering module that is part of said hub or logically distinct from said hub and acts on that information on dearth and surplus of parts and products to attempt to broker deals between or among entities that have dearth and surplus of the same part or product, whereby the dearth and surplus are eliminated or mitigated.

7. A system as in claim 6, where said information is received from said aggregating module.

8. A system as in claim 6, where one or more said entities with dearth in a certain said part or product can be matched with one or more said entities with surplus in the same said part of product.

9. A system as in claim 8, where said brokering module brokers a deal among one or more said entities with said dearth and one or more said entities with said surplus.

10. A system as in claim 9, where each said entity can choose whether they would like to participate in the brokered deal.

11. A system as in claim 10, where the identity of each said entity is kept secret until after said brokered deal is complete, whereby said entities cannot broker said deal without said hub.

12. A system as in claim 8, where said entities are only matched within brokering groups, where a single said brokering group contains zero or more said entities, and the group of said entities can be within a single supply chain, across supply chains, or from within and outside of any number of supply chains.

13. A system as in claim 12, where each said entity can be part of zero or more brokering groups.

14. A system as in claim 13, where each said brokering group can be assigned by said hub or by another said entity acting with authority from said hub.

15. A system as in claim 13, where said entities can opt to and refuse to participate in said brokering group.

16. A system as in claim 2, wherein
said information transferred across the supply chain is done so via said hub;
said messages contain reference to one or more said messages that are its causal antecedents;
said references contained are analyzed by said aggregation element;
said aggregation element uses the analysis to build a dictionary of cross-references for information transferred in said messages;
said analysis is stored in said database; and
said dictionary can be reported to said one or more business entities or said suppliers via said order collaboration system.

17. A system as in claim 1, including a feedback element capable of obtaining feedback information for a design process in response to supply chain performance.

18. A system as in claim 17, wherein said feedback information includes information relating to at least one of: selected preferred parts, selected preferred suppliers at one of said multiple tiers, selected parts that do not require new approval for use, selected preferred suppliers that do not need approval.

19. A system as in claim 1, including a compliance element capable of reviewing and enforcing compliance with contract terms between the one or more business entities and its suppliers.

20. A system as in claim 19, wherein contract compliance includes at least one of: delivery price, delivery quantity, price-quantity breakpoints, terms for parts returns, and delivery methods.

21. A system as in claim 1, including an allocation element capable of directing said suppliers to allocate parts in relatively short supply to selected projects.

22. A system as in claim 1, including a blind-design element capable of directing said suppliers to use any design that meets design specifications.

23. A system as in claim 22, wherein said blind-design element is responsive to a comparison of an estimated cost of optimization and an estimated possible cost savings due to design specification.

24. A method for operating an order collaboration system for an extended supply chain, including steps of
receiving a request from one or more business entities regarding supply chain information relevant to one or more designs or parts used in designs;
determining which data is relevant to said request, wherein said data is derived from one or more suppliers across one or more supply chains or past business records associated with said manufacture and is related to at least one of the following: price of at least one electronic or computer part, quantity available of said electronic or computer part, delivery schedules for said electronic or computer part, backorders, supply interruptions, exceptional events and contracts, and said data is stored in a database coupled to a hub;
aggregating said data in such a way that said aggregated data is responsive to said request; and
generating a report and presenting said report to said one or more business entities, wherein said report is responsive to said request.

25. A method as in claim 24, wherein said request pertains to determining whether a contract manufacturer is complying with the terms of a contract.

26. A method as in claim 24, wherein said request pertains to comparing the overall projected cost of a particular design based upon prices from multiple suppliers.

27. A method as in claim 24, wherein said request pertains to determining the most cost efficient way to manufacture a design.

28. A method as in claim 24, wherein said step of aggregating includes evaluating the supply chain performance of multiple tiers of suppliers.

29. A method as in claim 24, including a step of directing said suppliers to allocate parts in relatively short supply to selected projects.

30. A method as in claim 24, including a step of directing said suppliers to use any design that meets design specifications based upon a comparison of an estimated cost of optimization and an estimated possible cost savings due to design specification.

31. A method as in claim 24, wherein said step of aggregating includes a step of analyzing messages transferred through the hub and constructing a cross-reference dictionary of information passed in the messages.

32. A method as in claim 24, wherein said step of aggregating includes determining dearth and surplus of parts and products at all known suppliers, manufacturers and other entities.

33. A method as in claim 32, wherein one or more said suppliers, manufacturers, or other said entities with said dearth in a certain said part or product are matched with one or more said suppliers, manufacturers, or other said entities with said surplus in the same said part or product.

34. A method as in claim 33, wherein a deal is brokered among one or more said suppliers, manufacturers, or other said entities with said dearth in a certain said part or product and one or more said suppliers, manufacturers, or other said entities with said surplus in the same said part or product.

35. A method as in claim 34, wherein said deal is brokered only among said suppliers, manufacturers, and other said entities within the same said brokering group, where said brokering group is a set of zero or more said suppliers, manufacturers, other said entities, and other said brokering groups.

36. A method as in claim 35, wherein said suppliers, manufacturers, and other said entities can be in zero or more brokering groups.

37. A method as in claim 35, wherein said suppliers, manufacturers, and other said entities can opt to be in or can opt to be excluded from each said brokering group.
